(19) United States
(12) Patent Application Publication
(10) Pub. No.: US 2005/0128927 A1
(43) Pub. Date: Jun. 16, 2005

(54) Electrostatic actuator for contact probe storage device

(75) Inventors: Donald James Milligan, Corvallis, OR (US); John Paul Harmon, Albany, NY (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT CO., L.P.

(21) Appl. No.: 10/734,153

(22) Filed: Dec. 15, 2003

(51) Int. Cl. G11B 9/00

(52) U.S. Cl. 369/126

(57) ABSTRACT

An electrostatic actuator for a contact probe storage device has a first electrode; a second electrode supported in a predetermined spaced essentially parallel relationship with the first electrode by resilient members; and a probe configured to engage a medium in which data indicative topographical features are formed, the probe being mounted on the second electrode so as to extend away from the first electrode, one of the first and second electrodes being configured to have a voltage selectively applied thereto to attract the first and second electrodes toward one another and move the probe away from the medium.

### BACKGROUND OF THE INVENTION

Contact probe storage technology provides a method for ultrahigh density storage at a high speed. Most contact probe storage devices utilize arrays of cantilever beams with heated tips. The tips of the probes are kept in contact with a polymer media with a load determined by the bending of a cantilever beam on which the probe is supported. When heated sufficiently the probe can write data by locally fusing and forming pits in the media. Reading is carried out electrically by sensing a change in the impedance between the probe tip and a conducting layer below the media, or thermally by the change in the heat transfer characteristics when the probe tip is in a pit. The media is placed on a platform that can be moved in the x and y directions with respect to the tip or probe by a precision micromover.

One problem with cantilever devices of this type is the force needed to overcome the frictional forces resulting from all the cantilevers in continuous contact with the media. In addition, keeping the probe tips in continuous contact with the media results in tip wear.

### BRIEF DESCRIPTION OF THE DRAWINGS

The various aspects and features of the exemplary embodiment of the invention will become more clearly appreciated as a description of thereof is given with reference to the following drawings.

FIG. 1 is a schematic plan view of an embodiment of the invention.

FIG. 2 is a side sectional view as taken along section line II-II of FIG. 1.

FIG. 3 is a side sectional view showing the sensing tip of the probe which is mounted on the actuator, resting against a portion of a medium in which there is no data indicative topographical feature (e.g. no recess, debit, or mound) at the coordinates at which the tip is located.

FIG. 4 is a side sectional view showing the sensing probe tip resting against a portion of a medium in which there is a data indicative topographical feature (e.g. a recess or debit) at the coordinates at which the probe tip is located and which reduces the amount by which the probe is deflected away from the medium.

FIG. 5 is a side sectional view showing the sensing arrangement withdrawn from the medium in response to the application of a voltage across the electrodes which form part of a capacitance sensing arrangement that detects the change in distance therebetween in response to the tip encountering a data indicative topographical feature.

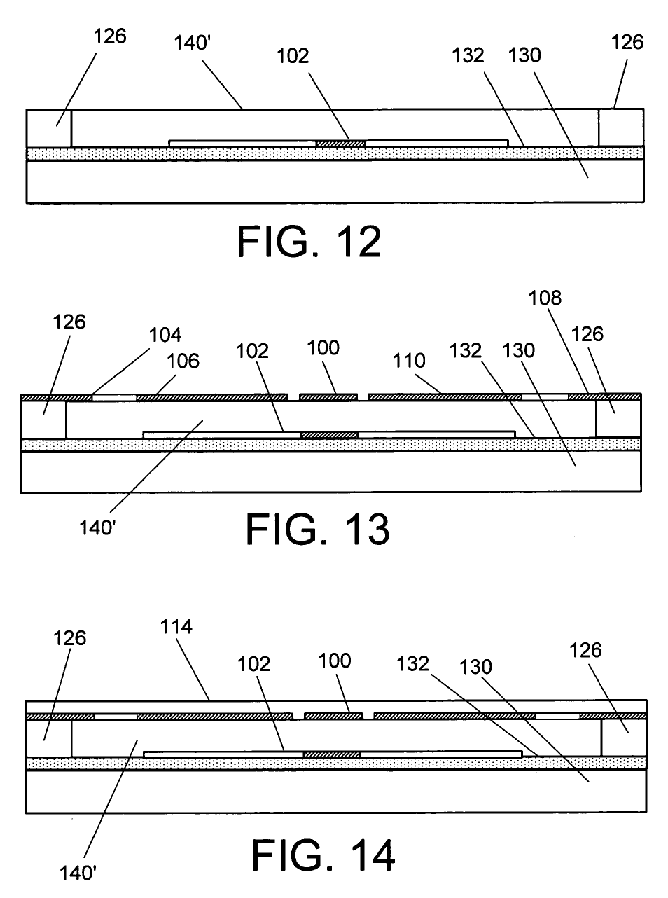

FIG. 6 is a plan view of showing an example of the configuration in which the upper electrode and flexures/traces which are associated therewith, can be formed.

FIG. 7 is plan view of a lower electrode which is shaped so as to conform to the shadow of the upper electrode shown in FIG. 6.

FIGS. 8-23 are views depicting the steps which are carried out in connection with the fabrication of the exemplary embodiment.

### DETAILED DESCRIPTION OF THE EXEMPLARY EMBODIMENTS

The embodiments of the invention relate to an actuator for contact probe storage device which is configured to undergo electrostatic actuation, so the probe tip can be drawn away from a medium and allowed to contact the media only when needed. The ability to selectively disengage the probe tip from the media when not reading or writing data substantially reduces the force required from the mover. If the probe tips are disengaged from the media when not in use, wear is significantly reduced.

In addition to actuation, the parallel plate electrodes which enable the electrostatic attraction also allow capacitive sensing of data.

Although only one probe actuator is shown in the drawings it will be understood that a plurality of these arrangements can be placed in an array with a 40 μm (for example) pitch, with multiplexing used to address specific probes.

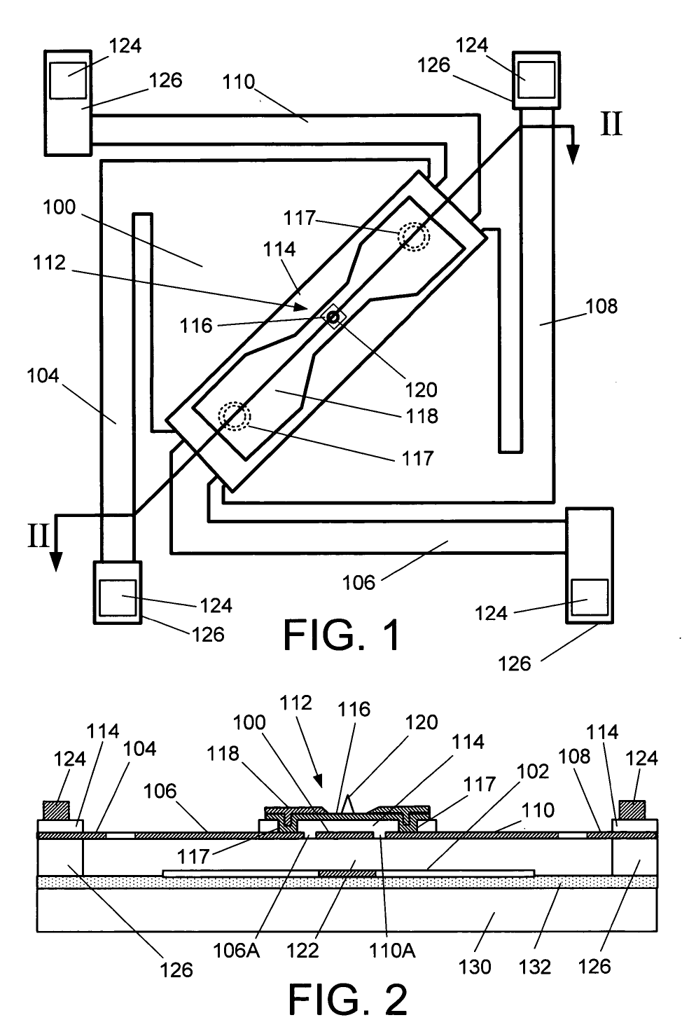

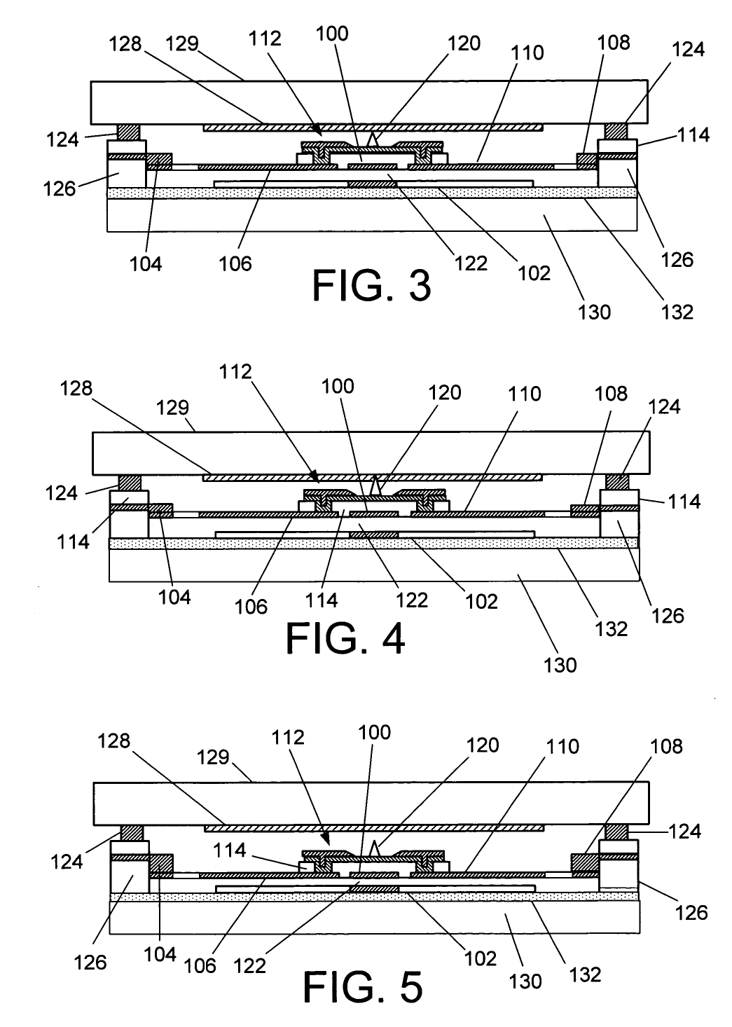

FIGS. 1 and 2 show an exemplary embodiment. In this arrangement an upper electrode 100 is supported in a spaced relationship over a fixed lower electrode 102, by way of resilient flexures 104-110. A heater generally denoted by the numeral 112 is supported on an upper side of the upper electrode 100 and electrically separated therefrom by a layer of non-conductive thermally insulative material 114. The heater 112 comprises in part, a layer of metal 116 which in the embodiment takes the form of TaAl by way of example. The metal layer 116, which is formed over the insulative layer 114, is electrically connected with the traces 106 and 110 via portions of the layer 116 which extend through vias 117. This establishes an electrical connection between the heater 112 and the flexures 106, 110. Because all of the flexures are, in this embodiment, also formed of the same metal (TaAl) they can also function as traces via which electrical signals/current can be transmitted.

An aluminum layer 118 is formed over the TaAl layer 116 to complete the heater 112. A recess is formed in the Al layer 118 to expose a portion of the TaAl layer 116. A probe 120 is formed on the TaAl layer in the illustrated manner.

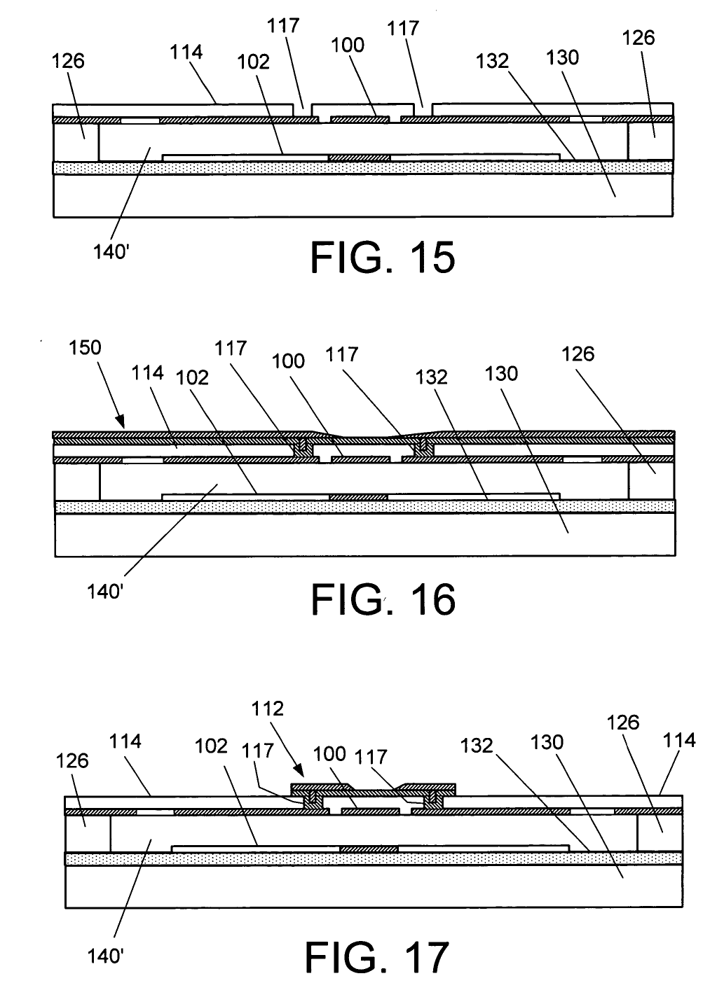

As shown in FIG. 6, the traces/flexures 106, 110 are separated from the upper electrode 100 by gaps 106A and 110A. With this arrangement the heater 112 can be supplied current via flexures/traces 106 and 110, while the upper electrode can separately have a voltage applied via flexures/traces 104, 108. The overall configuration of the upper electrode 100 and the flexures 104-110 can be likened to a “pinwheel” wherein opposed pairs of flexures extend at right angles to each of a pair of axes which pass through an imaginary center of rotation of the pinwheel and which axes intersect each other essentially at right angles.

The flexures 104 and 108 also provide part of a circuit whereby the upper electrode 100, the lower electrode 102 and an air gap 122 therebetween, forms a capacitor which enables the change in distance between the upper and lower electrodes 100 and 102, which is induced by the probe 120 engaging a data indicative topographical feature, to be sensed.

The areas of the upper and lower electrodes 100, 102 are selected to minimize the mass, while providing adequate area for the parallel plate capacitor arrangement just mentioned. The gap between the fixed lower electrode 102 and the actuating upper electrode 100 is small to maximize the capacitance, but large enough to provide adequate displacement without pulling down when a voltage is applied across the upper and lower electrodes 100, 102.

As will be appreciated, although the upper and lower electrodes 100, 102 constitute an essential part of an actuator arrangement, they also constitute a part of a sensing arrangement which enables the change in distance to be detected during the periods the actuating voltage is not applied.

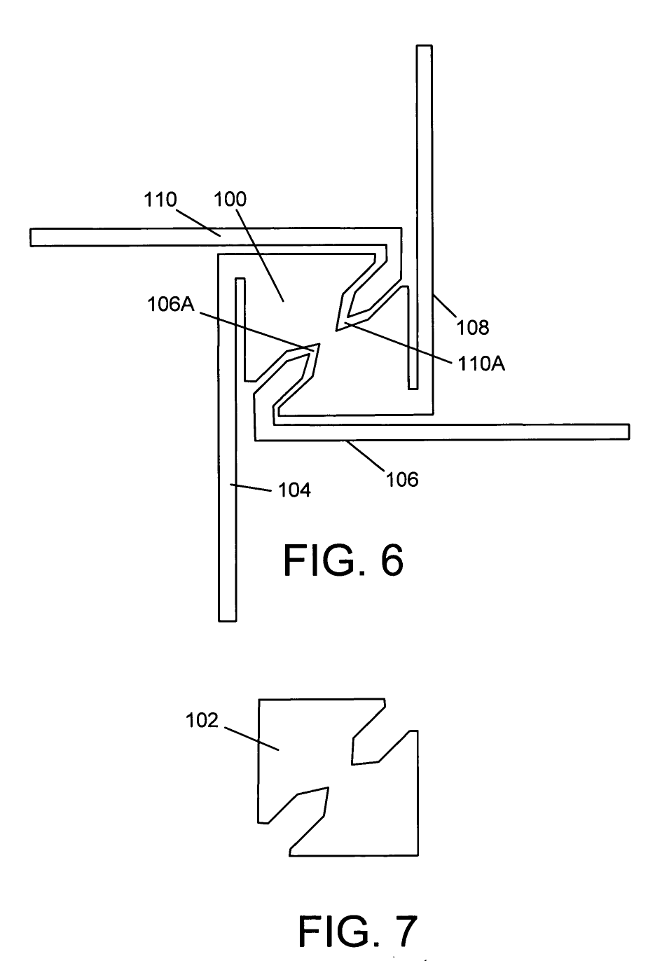

A spacer arrangement comprising spacers 124 are provided on the mounting portions 126 which support the free ends of the flexures 104-110. These spacers 124 have dimensions which are selected allow the probe 120 to protrude, when the flexures 104-110 are fully relaxed, above the upper level of the spacers 124 to a degree that disposition of a medium 128 (supported on a substrate or die 129) on the spacers 124 (in the manner shown in FIG. 3) deflects the probe platform (viz., the upper electrode 100/heater 112) downwardly toward the lower fixed electrode 102 and causes the probe 120 to apply a predetermined load to the surface of medium 128.

This embodiment provides a high resonant frequency for fast operation. The stiffness of the flexures 104-110 are low enough to allow adequate z-axis displacement of the probe platform 100/112 at a reasonable voltage (e.g. 16 volt), while the load on the media from the suspension restoring force provided by the flexures 104-110 is within allowable limits. A suitable load is, merely by way of example, is 100 nN. This is based on current CPS devices is merely an example and in no way limiting as to load which can be selectively exerted.

### EXAMPLE

An optimized device exhibits parameters which are summarized in the table below. The load on the probe tip when writing to media is near the desired target of 100 nN if the gap is set so that the probe tip is deflected 200 nm from the relaxed position. The voltage needed to pull down the probe tip ⅓ of the 900 nm gap is 16 volts.

The nominal capacitance is 1.3 fF. The difference in capacitance 0.2 fF is produced assuming a media film of 150 nm. Although small, this capacitance is of a detectable magnitude.

The fundamental frequency of the device is 300 kHz. However, this design could be optimized for a higher frequency by increasing the stiffness of the flexures and enable a target of 1 Mhz for example, to be achieved. Nevertheless, this would involve a tradeoff wherein increased load on the media and/or increased voltage needed to withdraw the probe 120 from contact with the medium 128.

Lowering the mass of the device could also increase the frequency. This, however, tends to lower capacitance and raise actuation voltage.

TABLE

| Parameter | Value |
|---|---|
| Write Load | 90 nN |
| Actuation Voltage | 16 V |
| Capacitance | 1.3 fF |
| Capacitance Delta | 0.2 fF |
| Effective Mass | 1.4 e-13 kg |
| Frequency (1^{st} Mode) | 300 kHz |
| Spring Constant | 0.45 N/m |

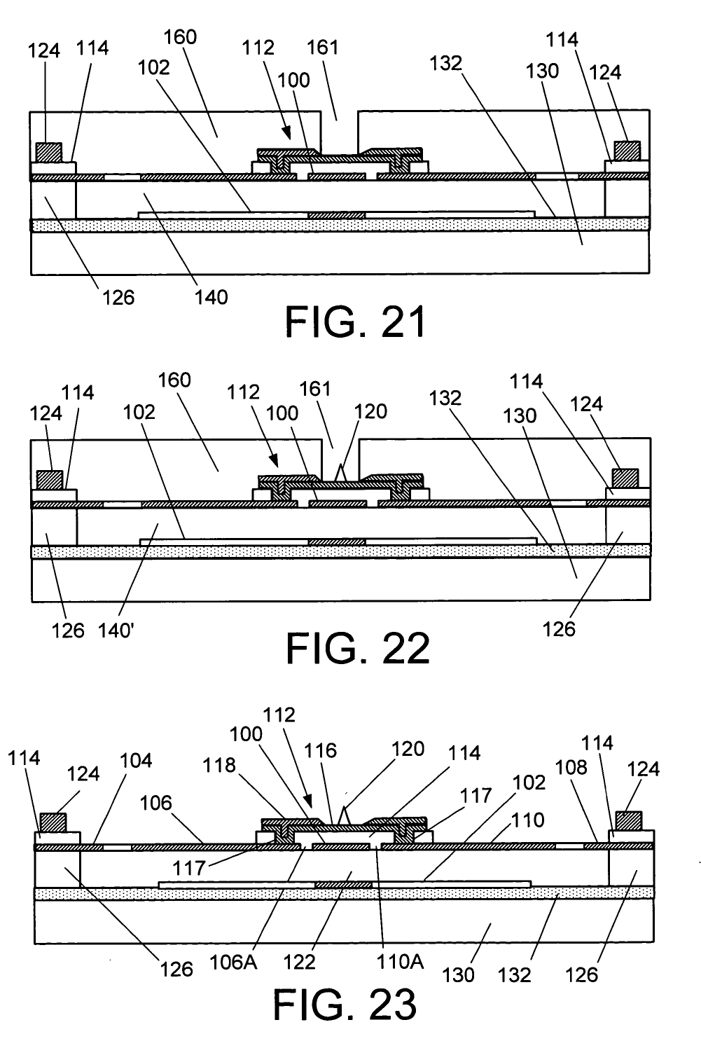

FIGS. 8-23 show steps which can be used to fabricate the above described embodiment. It will be appreciated that these steps which are set forth below are merely exemplary and that variations/modifications are possible. The materials which are mentioned in connection with each of the layers can be varied as deemed appropriate.

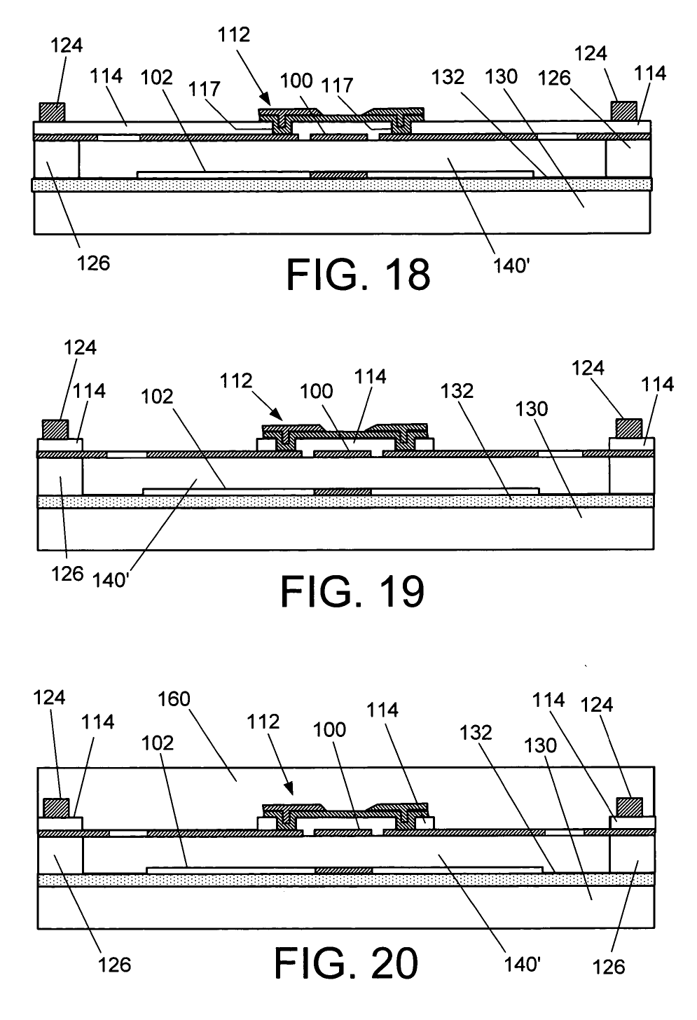

In FIG. 8 a silicon wafer 130 is treated to produce a thermal oxide layer 132 having a thickness of about 500 nm. Next, as shown in FIG. 9, an aluminum (Al) layer is deposited on the oxide layer 132 and etched to form the lower fixed electrode 102. In this embodiment, this electrode 102 has a shape similar to that shown in FIG. 7. Following this, a 1 μm of PECVD oxide is deposited and etched to set an electrode gap (viz., a gap between the upper and lower electrodes 100, 102) via the formation of mounting portions 126 in the manner illustrated in FIG. 10.

Next, as depicted in FIG. 11, a 2.0 μm 1st sacrificial polysilicon layer 140 is deposited and subsequently planarized using CMP (see FIG. 12), to a level flush with the tops of the mounting portions 126. Following this, a layer of TaAl is deposited over the surface of the polysilicon 140′ and the mounting portions 126 and etched (FIG. 12) to form the flexures 104-110 and upper electrode 100 having configuration similar to that shown in FIG. 6. This being completed, the following sequence of operations, respectively depicted in FIGS. 14-23, is executed.
FIG. 14—Depositing, masking and etching of a 200 nm of PECVD oxide to form the layer of non-conductive thermally insulative material 114 which insulates a resistor structure, that forms a part of the heater 112, from the upper electrode 100. This also forms pads of insulative material (designated by the same numeral 114) with the same thickness as that associated with the resistor structure, on top of the TaAl layer above the mounting portions 126.
FIG. 15—Etching of vias 117 to TaAl layer defining flexures/traces 106, 110 to form the resistor traces.
FIG. 16—Depositing a metal stack 150 of 100 nm Al over 50 nm TaAl, masking and wet etching the Al layer to form a resistor which forms a functional part of the heater 112.
FIG. 17—Masking and etching the metal stack 150 to complete the resistor trace of heater 112.
FIG. 18—Depositing, masking and etching a 600 nm layer of Ta/Au to form spacers 124 and set the gap between media and probe tip.
FIG. 19—Masking and etching PECVD oxide 114 to expose the upper surface of the upper electrode and traces 104-110.
FIG. 20—Depositing 1 um of a 2nd sacrificial polysilicon 160.
FIG. 21—Masking and etching opening 161 in the sacrificial polysilicon 160 to the level of the resistor of the heater 112.
FIG. 22—Depositing a 500 nm probe 120.
FIG. 23—Etching the sacrificial poly layers with SF6 or XeF2 to reveal the completed arrangement.

This results in the arrangement illustrated in FIG. 2. Accordingly, as shown in FIG. 3 it is now possible to bond a 150 nm media 128 on a die or substrate 129, and mount the same on a micromover (not shown) and move the die 129 into the illustrated position atop of the spacers 124. As noted above, this induces an exemplary situation wherein the engagement between the medium 128 and the tip or probe 120 induces a deflection of about 200 nm from the relaxed position. This situation induces an exemplary load of about 90 N.

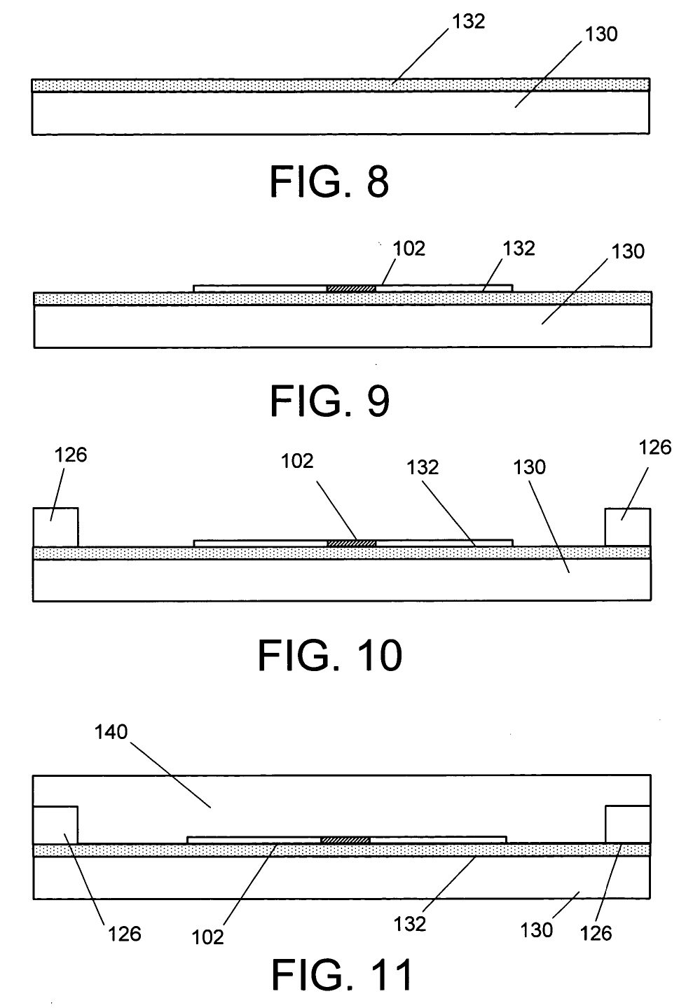

In the event that the surface of the medium 128 is not smooth or free of data indicative topographical features as in the case illustrated in FIG. 3, and the probe or tip 120 is able to engage a data indicative topographical feature such as shown in FIG. 4, the amount of probe deflection is reduced to about 50 μm with a reduced load of about 22 nN.

This change in deflection can be detected through the change in capacitance between the upper and lower electrodes 100, 102. As shown in the above table, this change can be about 0.2 fF, which while being small is measurable and the change in deflection can be detected.

Although this invention has been described with reference to only a single embodiment, it will be understood that variants and modifications of the invention, which is limited only by the appended claims, will be readily envisaged by the person skilled in the art to which this invention pertains or most closely pertains, given the preceding disclosure. For example, as shown in FIG. 6, the length of the flexures are not fixed and can be elongated with respect to the area of the upper electrode for the purposes of modifying the resonance frequency etc. The shape of the electrodes is not fixed and can be circular or any other desired configuration.

In the above type of arrangement, it is additionally possible for the heater/probe arrangement to carry out both imaging and reading using a thermomechanical sensing concept. The heater 112 can be used for writing and thermal readback sensing by exploiting a temperature-dependent resistance function. For writing the heater can be elevated to a temperature of 500-700° C. (for example).

For sensing, the heater 112 can be operated at about 200° C. This temperature is not high enough to soften the polymer medium which can consist of one more polymer layers including an upper layer of polycarbonate or polymethylmethacrylate (PMMA), but allows the molecular energy transfer between the structure on which the probe is carried, and the medium, to remove heat and thus provide a parameter which allows the presence/absence of a data indicative topographical feature to be detected.

1. An electrostatic actuator for a contact probe storage device comprising:
a first electrode;
a second electrode supported in a predetermined spaced essentially parallel relationship with the first electrode by resilient members; and
a probe configured to engage a medium in which data indicative topographical features are formed, the probe being mounted on the second electrode so as to extend away from the first electrode, one of the first and second electrodes being configured to have a voltage selectively applied thereto to attract the first and second electrodes toward one another and move the probe away from the medium.

2. An electrostatic actuator as set forth in claim 1, wherein the first and second electrodes are configured to produce a capacitance which varies with the displacement of the probe with respect to the medium.

3. An electrostatic actuator as set forth in claim 1, wherein the second electrode is supported by a plurality of flexible extension members.

4. An electrostatic actuator as set forth in claim 3, wherein a first pair of the flexible extensions are configured to apply a voltage to the second electrode.

5. An electrostatic actuator as set forth in claim 4, further comprising a heater disposed on the second electrode, the heater being electrically isolated from the second electrode and electrically connected with a second pair of the flexible extensions which are configured to supply electrical current to the heater.

6. An electrostatic actuator as set forth in claim 3, wherein the flexible extension members are made of an electrically conductive material.

7. An electrostatic actuator as set forth in claim 3, wherein the flexible extension members each have an electrically conductive portion.

8. An electrostatic actuator arrangement for a contact probe storage device comprising:
a probe configured to engage a medium in which data indicative topographical features are formed; and
linear acting electrostatic motor means for selectively drawing the probe out of engagement with the medium.

9. An electrostatic actuator arrangement as set forth in claim 8, further comprising:
capacitor means for sensing displacement of a probe with respect to the medium which displacement is induced by engagement between the probe and a data indicative topographical feature.

10. An electrostatic actuator arrangement as set forth in claim 9, wherein the capacitor means and the linear acting electrostatic motor means commonly comprise:
a first electrode; and
a second electrode supported in a predetermined spaced essentially parallel relationship with the first electrode.

11. An electrostatic actuator arrangement as set forth in claim 10, wherein the second electrode comprises flexible support means for supporting the second electrode in the spaced essentially parallel relationship with the first electrode.

12. An electrostatic actuator arrangement as set forth in claim 11, wherein the flexible support means further comprise means for establishing an electrical connection with the second electrode.

13. An electrostatic actuator arrangement as set forth in claim 11, further comprising a heater supported on and electrically isolated from the second electrode and disposed proximate the probe.

14. An electrostatic actuator arrangement as set forth in claim 13, wherein the flexible support means further comprise means for passing electrical current to the heater.

15. A method of making an electrostatic actuator for a contact probe storage device comprising:
forming a first electrode on a base member which has supports formed thereon;
forming a second electrode which is configured to be supported by the supports on the base member so as to extend in a predetermined spaced essentially parallel relationship with the first electrode; and
configuring one of the first and second electrodes to have a voltage applied thereto which attracts the other of the first and second electrodes theretoward.

16. A method as set forth in claim 15, further comprising:
forming a probe which is supported on the second electrode and which is configured to engage a medium in which data indicative topographical features are formed; and
forming spacers which support the medium in a predetermined spatial relationship with the probe.

17. A method as set forth in claim 15, comprising:
forming a plurality of elongate flexures which each have an end supported by one of the supports, and which each have an end juxtaposed the second electrode;
configuring one pair of flexures to be integral with the second electrode and a second pair of flexures to be connected to the second electrode through an electrically insulative member; and
using the flexures to support the second electrode in the predetermined spaced essentially parallel relationship with the first electrode.

18. A method as set forth in claim 17, further comprising forming the flexures to be electrically conductive or to have an electrically conductive portion.

19. A method as set forth in claim 18, further comprising:
forming a heater on the second electrode;
electrically isolating the heater from the second electrode and configuring the heater to be electrically connected with the second pair of flexures.

20. A method as set forth in claim 16, further comprising configuring the first and second electrodes to form a capacitor wherein the change in distance between the first and second electrodes is measurable and usable as a signal indicative of the probe having engaged a data indicative topographical feature on the medium.

21. A contact probe storage device comprising:
a medium in which data indicative topographical features are formed; and
at least one electrostatic actuator which is configured so that the actuator and the medium are selectively movable relative to one another, the at least one actuator comprising:
a first electrode;
a second electrode supported in a predetermined spaced essentially parallel relationship with the first electrode by resilient members; and
a probe configured to engage the medium in which data indicative topographical features are formed, the probe being mounted on the second electrode so as to extend away from the first electrode, one of the first and second electrodes being configured to have a voltage selectively applied thereto to attract the first and second electrodes toward one another and move the probe away from the medium.

22. A contact probe storage device as set forth in claim 21, wherein the first and second electrodes are configured to produce a capacitance which varies with the displacement of the probe with respect to the medium.

23. A contact probe storage device as set forth in claim 21, wherein the second electrode is supported by a plurality of flexible extension members.

24. A contact probe storage device as set forth in claim 23, wherein a first pair of the flexible extensions are configured to apply a voltage to the second electrode.

25. A contact probe storage device as set forth in claim 24, further comprising a heater disposed on the second electrode, the heater being electrically isolated from the second electrode and electrically connected with a second pair of the flexible extensions which are configured to supply electrical current to the heater.

26. A contact probe storage device as set forth in claim 23, wherein the flexible extension members are made of an electrically conductive material.

27. A contact probe storage device as set forth in claim 23, wherein the flexible extension members each have an electrically conductive portion.
